(19) United States
(12) Patent Application Publication
(10) Pub. No.: US 2004/0029662 A1
(43) Pub. Date: Feb. 12, 2004

(54) Method of and apparatus for shaft speed detection by monitoring pump output

(76) Inventor: Stephen Mark Hearn, Cheshunt (GB)

Correspondence Address: REISING, ETHINGTON, BARNES, KISSELLE, P.C., P O BOX 4390, TROY, MI, 48099-4390, US

(21) Appl. No.: 10/387,736

(22) Filed: Mar. 13, 2003

(30) Foreign Application Priority Data
Mar. 14, 2002 (GB) 0206024.2

(51) Int. Cl. F16H 59/00

(52) U.S. Cl. 474/18

(57) ABSTRACT

A system for determining the speed of a pump (6) used to supply hydraulic fluid for a control system is disclosed. The pump output exhibits small pressure fluctuations and these are detected by a transducer (50) and provided to a data processor (54) which analyses the output of the transducer and calculates the speed of the pump.

The present invention relates to a method of and apparatus for monitoring the speed of an input shaft which is drivingly connected to a pump. The method and apparatus may be employed within a number of environments, and is particularly suitable for use within au avionics environment.

It is often desirable to know the speed of an input shaft to a machine, such as a gear box. Indeed, in some applications, such as belt driven continuously variable transmission systems it is particularly important to know the input shaft speed. The reason for this is that, in such systems, a segmented belt passes between two variable diameter pulleys. Each pulley is formed by opposing inclined flanges, thereby forming a V shaped groove in between the pulleys. The pulleys are moveable with respect to one another in order to control the width of the groove, and hence the effective diameter of the pulley formed by the opposed flanges. Within high reliability environments, it is important that the working life of such an arrangement should be maximised. The pulleys engage on either side of the segmented belt. The pressure with which they engage the sides of the belt is controllable by the system designer. Too low a pressure and the belt with slip with respect to the pulley. This causes significant mechanical wear leafing to failure of the system. However, too high a clamping pressure is also disadvantageous as this too gives rise to premature failure of the belt because there is inevitably a small amount of sliding motion between the belt and the inclined flanges during the transition of the segments from undergoing straight line motion (between the pulleys) to circular motion (around each pulley). In order to control the clamping pressure to a desired range, it is highly advantageous that the input speed of the gear box is known to the gear box controller, as well as the output speed of the gear box. From this, the controller can estimate a suitable clamping pressure which is not so low that slip might occur, but not so high that excessive wear occurs.

It is highly desirable that the input shaft of such a transmission is provided with a speed sensor. However, in order to enhance safety by providing dissimilar dual redundant systems, it is advantageous that a back-up speed measuring system be provided. It may also be the case that, in some retrofit applications, existing wring harnesses do not contain enough cables to allow all the desired sensors to be configured, and in such cases it may not be possible to include a dedicated input shaft sensor, and as a result such speed information may have to be deduced from other sensors that were originally provided for other tasks.

GB 2302418 discloses a diagnostic device for diesel engines where a clip-on sensor is attached to a line between an injection pump and an injection nozzle. The nozzle is, of course, controlled to be injecting for predetermined periods of time but otherwise to be non-injecting. Hence the pressure fluctuations are quite large.

U.S. Pat. No. 5,417,194 discloses an arrangement in which output pressure pulses from a positive displacement fuel pump within a diesel engine are detected. The pump is driven from a cam and hence the pressure pulses are correlated with the rotational position of the engine in a working cycle. The pressure pulses are used as a datum for triggering an injection cycle.

In each of the above documents the flow from the pump, varies considerably over time as the injectors are periodically actuated. Furthermore the output pressure of the pump also cyclically varies as the pistons within the pumps reciprocate. These pumps therefore have a large variation in output over a pump operating cycle.

According, to a first aspect of the present invention, there is provided a method of estimating the rate of rotation of an input shaft drivingly connected to a pump which, in use, has a substantially constant output over an operating cycle of the pump, wherein a pressure transducer is responsive to pressure fluctuations at the output of the pump, and the pressure fluctuations are used to determine the speed of the input shaft.

It is thus possible to provide data representative of input shaft speed based on pump pressure fluctuations.

Preferably the pressure sensor is downstream of the pump. Thus, the pressure sensor can provide a dual role of determining the fluid pressure at or adjacent the output of the pump and also indicate pump/input shaft speed. Thus the DC or low frequency response of the sensor is an indication of fluid pressure, whereas a higher frequency output is indicative of the speed.

Preferably the output signal of the pump pressure transducer is signal processed in order to extract the pump speed information signal from its output. The signal processing may be as simple as filtering the output of the pump signal, for example by a high or band pass filter. Alternatively more sophisticated techniques such as locking to the signal using a phased locked loop to extract it may also be applied. Signal processing may be performed in the analogue or digital domains.

Preferably the pump is connected to the input shaft by a fixed ratio gear mechanism. Thus the speed of the input shaft is directly related to the pump speed.

The pump may provide a plurality of pressure pulses per operating cycle (e.g. one revolution of a pump input shaft) of the pump. Thus a knowledge of both the gear ratio between the input shaft and the pump, and the number of pressure pulses per operating cycle of the pump needs to be known in order to provide the correct conversion ratio between the pump ripple frequency and the input shaft rotational speed.

Advantageously the pump is provided as part of a variable ratio transmission, and the pump speed signal is provided to a clamp pressure controller in order that the controller has knowledge of the input shaft speed of the continuously variable transmission. Advantageously this information is provided in conjunction with data from speed sensors and, in the context of avionics environments, also data from full authority digital engine controllers, FADEC's.

According to a second aspect of the present invention, there is provided an apparatus for estimating the rate of rotation of an input shaft drivingly connected to a pump, comprising a pressure transducer provided adjacent the pump in a position where it is responsive to pressure fluctuations occurring as a result of operation of the pump, and a processor for receiving an output of the pressure transducer and deriving a measure of the input shaft speed therefrom.

The processor may be provided as part of a further controller, such as a clamp pressure controller within a continuously variable transmission.

The present invention will further be described, by way of example, with reference to the accompanying drawings, in which:

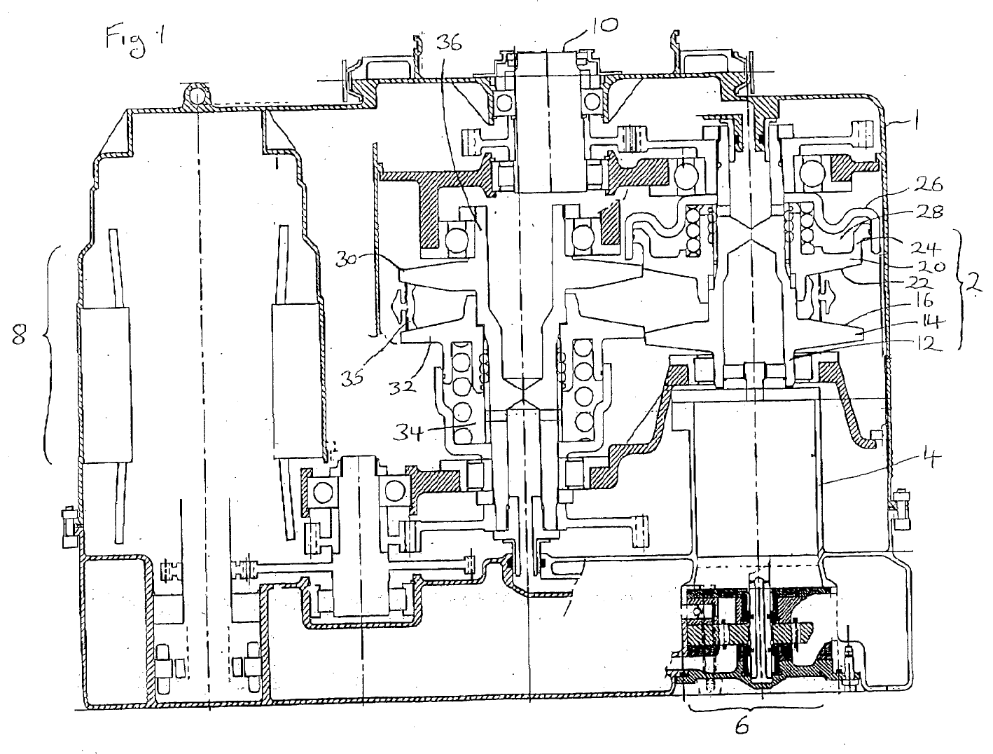

FIG. 1 schematically illustrates an aeronautical generator wherein the generator includes a continuously variable transmission incorporating a segmented belt;

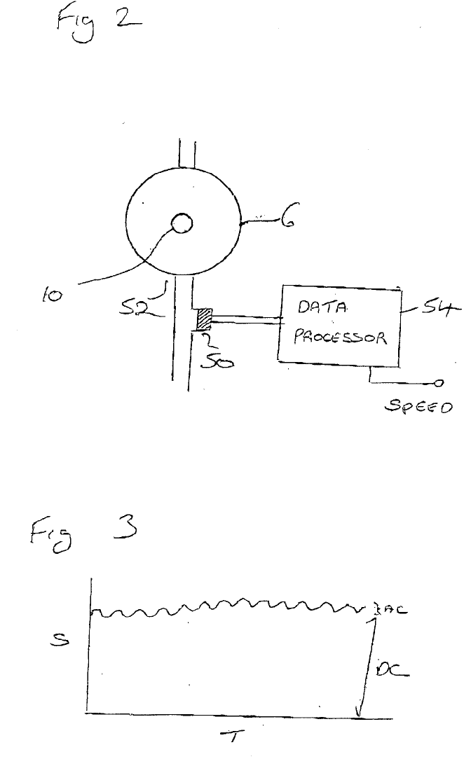

FIG. 2 schematically illustrates a speed detection system constituting an embodiment of the present invention;

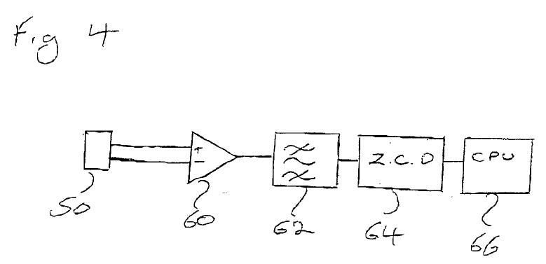

FIG. 3 is a graph schematically illustrating the output of the pressure sensor in FIG. 2; and

FIG. 4 schematically illustrates the signal processing steps undertaken to recover the speed data.

The generator shown in FIG. 1 comprises a housing 1 which encloses a continuously variable transmission generally designated 2 and utilising a drive belt, a low pressure pump 4, a high pressure pump 6, a generator, generally designated 8, and an oil system disposed throughout the housing 1.

The belt drive 2 enables the variable speed of an input shaft 10 which receives a drive from a spool of a gas turbine engine to be converted to a near constant speed such that the generator 8 can be run at a near constant speed. In order to do this, a first shaft 12 of the belt drive mechanism carries a flange 14 which defines an inclined surface 16 against which a drive belt bears. The shaft 12 also carries a coaxially disposed movable flange 20 drivingly connected to the shaft 12 via a splined portion (not shown). The movable flange 20 defines a further inclined surface 22 facing towards the surface 16, which surfaces serve to define a V-shaped channel whose width can be varied by changing the axial position of the flange 20 with respect to the fixed flange 14. The flange 20 has a circularly symmetric wall 24 extending towards and co-operating with a generally cup shaped element 26 carried on the shaft 12 to define a first hydraulic chamber 28 therebetween which is in fluid flow communication via a control duct (not shown) with an associated control valve. Similarly, a fixed flange 30 and a movable flange 32 are associated with a second shaft 36 and serve to define a pulley operated by a second hydraulic control chamber 34. A steel segmented belt 35 having a cross-section in the form of a trapezium, with the outer most surface being wider than the inner most surface is used to interconnect the first and second variable ratio pulleys formed between the pairs of fixed and movable flanges, respectively, in order to drivingly connect the pulleys.

The position of each movable flange with respect to the associated fixed flange is controlled by the hydraulic actuators. Since the interconnecting belt is of a fixed width, moving the flanges closer together forces the belt to take a path of increased radial distance. The interconnecting belt has a fixed length, and consequently as one movable flange is moved towards its associated fixed flange, the other movable flange must move away from its associated fixed flange in order to ensure that the path from an arbitrary starting point, around one of the pulleys, to the second pulley, around the second pulley and back to the fixed arbitrary staring point remains a constant distance.

It is important in such a pulley system that the position of the flanges can be well controlled. It is also important that the compressive force exerted upon the belt can be well controlled since belt wear and fatigue increases rapidly with compressive force but belt slippage is damaging to both the belt and the pulleys. Thus a controller or control system (not shown) is provided which controls both the drive ratio and the compressive load exerted on the belt.

In order to maximise belt life, the pressure controller seeks to minimise the clamp pressure on the belt consistent with ensuring that no belt slippage occurs. In order to do this, the controller receives data indicative of the speed of the input shaft 10. The controller can derive the speed of the continuously variable transmission output shaft since this is drivingly connected to the generator and consequently the generator output frequency is directly related to the output shaft speed. The controller would normally receive the input shaft speed information from a engine speed controller, such as a FADEC. Knowledge of the engine speed, and the ratio of the input step down gear train within the transmission enables the input pulley speed to be calculated.

The signal from the FADEC is extremely reliable as tic FADEC is used to provide information for the engine fuel control and cockpit instruments. However, it is possible that the connection between the FADEC and the generator control unit incorporating the belt clamp pressure controller could become damaged or disconnected resulting in a loss of speed information. It is also conceivable that a FADEC fault could develop causing loss of this input speed data.

In the event of loss of input speed data, system integrity is not compromised because the continuously variable transmission can operate in a default mode in which the clamp pressure controller applies a clamping pressure which is sufficient to ensure that the belt cannot slip. However, the use of this excess clamping force will reduce the working lifetime of the belt. However, if the input shaft speed to the gearbox is known, then the appropriate clamp pressure can bc calculated and set.

The high pressure pump 6 used to generate the control pressures for operating the continuously variable transmission pulleys is, in this example, a roller vane unit having eleven roller elements. It follows that since the high pressure pump is used to derive fluid for use in the control system, it is highly desirable that the pump output pressure should remain reasonably constant. This requirement makes the use positive displacement pumps undesirable as they have highly pulsating output pressure and the pressure pulses could propagate into the hydraulic control system for the variable transmission pulleys, possibly perturbing the operation of the control system. The control system also represents, in use, a continuous user of the fluid pumped by the high pressure pump. Thus the high pressure pump has to deliver fluid at its output substantially continuously. A roller-vane pump satisfies these conditions thereby minimising the pressure fluctuations experienced by the control system. Even so, the nature of the output from such a pump is that pressure fluctuations are created in the output corresponding to each of the roller elements. This results, in this example, in the pressure ripple at the output of the pump bring eleven times the rotational input speed of the pump which is itself directly related to the rate of rotation of the input shaft 10 and the rate of rotation of the pulley formed by the flanges 16 and 22. The pressure ripple is relatively small—certainly when compared with the fluctuations found in the prior art systems of GB 2302418 and U.S. Pat. No. 5,417,194 discussed hereinbefore.

As shown in FIG. 2, a pressure sensor 50 is provided downstream of the output 52 of the high pressure pump 6. The pump 6 is schematically shown as being drivingly connected to the input shaft 10. An output of pressure sensor 50 is provided to a data processor 54 which analyses its output in order to derive a measure into speed.

An output from the pressure sensor is schematically illustrated in FIG. 3. The output comprises a signal S which is formed of an alternating ripple, AC, superimposed on a varying or DC background. The DC background represents the pressure at the output of the pump, whereas the AC ripple is indicative of the pump speed. Thus, in order to determine the speed of the input shaft, it is necessary to determine the frequency of the AC component of the signal produced by the pressure transducer.

FIG. 4 schematically illustrates a signal processing arrangement in greater detail. As shown, the output of the pressure transducer 50 is buffered by an instrumentation amplifier 60 which serves to reject common mode signals at its input. Thus extraneous noise induced in both signal lines from the pressure transducer 50 to the inverting and non-inverting inputs, respectively, of the amplifier are rejected as this noise occurs in the same frequency and phase at both the inputs. The output of the amplifier 60 is connected to an input of a band pass filter 62 which serves both to filter out the DC component of the signal and also to reject high frequency components. The signal is then supplied to the input of a zero crossing detector 64 which produces an impulse each time the AC signal passes through a zero volt reference. Thus the time difference between each impulse corresponds to one half cycle of the AC signal. Thus by timing the intervals between the impulses, the frequency of the AC signal can be deduced. This can then be used to calculate the input shaft speed based on knowledge of the step down gear train and the pump's operating characteristics. Averaging may be applied in order to remove spurious results resulting from timing jitter.

In the present example, the input shaft speed in normal operation is expected to vary between 3500 and 7000 rpm. The pump characteristics and step down gearing are such that the ripple frequency will lie between approximately 600 and 1300 Hz. Thus this can be easily extracted without requiring expensive data capture hardware. The amplitude of the pump ripple will vary according to several factors, including pump design and pump speed. However, with suitable placement of the pressure transducer it is expected that pump ripple will be resolved at all relevant operating speeds.

Thus the data derived from the pump ripple can be used in conjunction with, or in place of, speed data from a speed sensor. Thus it enables, for example, a continuously variable transmission gear box to be retrofitted to an aircraft, even in situations where the existing wiring harness does not support enough connections to enable a dedicated speed sensor to be used.

The pulley control pressure is a key piece of information in the operation of the continuously variable transmission system. In the event that this is lost, for example due to sensor failure, it might be necessary to shut down the transmission unit. However, the use of a pressure sensor in older to deduce rotational speed means that a back up pressure sensor may be substituted in place of a conventional speed sensor thereby providing redundancy within the system.

It is thus possible to provide an estimate of rotational speed by monitoring pressure fluctuations in the output of a pump.

1. A method of estimating the rate of rotation of an input shaft drivingly connected to a pump which, in use, has a substantially constant output over an operating cycle of the pump, wherein a pressure transducer is responsive to pressure fluctuations at the output of the pump, and the pressure fluctuations are used to determine the speed of the input shaft.

2. A method as claimed in claim 1, wherein the number of pressure fluctuations is divided by the number of pressure pulses for one operating cycle of the pump to obtain a measure of pump speed.

3. A method as claimed in claim 2, wherein the measure of pump speed is modified by a gear ratio of a gear arrangement connecting the pump to the input shaft to obtain a measure of the speed of the input shaft.

4. A method as claimed in Claim 1, wherein an output of the pressure transducer is provided to a signal processor which extracts the signal corresponding to the pump ripple.

5. An apparatus for estimating the rate of rotation of an input shaft drivingly connected to a pump which, in use, has a substantially constant output over an operating cycle of the pump, wherein a pressure transducer responsive to pressure fluctuations at the output of the pump is provided and the pressure fluctuations are used to determine the rate of rotation of the input shaft.

6. An apparatus as claimed in claim 5, wherein the number of pressure fluctuations in a given period is divided by the number of pressure pulses for one operating cycle of the pump to obtain a measure of pump speed.

7. An apparatus as claimed in claim 6, wherein the measure of pump speed is modified by a gear ratio value of a gear arrangement connecting the pump to the input shaft to obtain a measure of the speed of the input shafts.

8. An apparatus as claimed in claim 5, wherein a data processor or a signal processor is responsive to the output of the pressure transducer and operates on the signal to extract the pressure fluctuations.

9. A continuously variable transmission including a pump and an apparatus for estimating the rate of rotation of an input shaft drivingly connected to the pump as claimed in claim 5.

10. A continuously variable transmission as claimed in claim 9, further comprising an hydraulic control system supplied with pressurised fluid by the pump and arranged to control a transmission ratio of the continuously variable transmission.

11. A continuously variable transmission as claimed in claim 9, wherein the pump is a roller-vane pump.

12. An acronautical generator driven by a continuously variable transmission as claimed in claim 9.
